(19) United States
(12) Patent Application Publication
(10) Pub. No.: US 2010/0177431 A1
(43) Pub. Date: Jul. 15, 2010

(54) INFORMATION STORAGE APPARATUS, ADJUSTMENT APPARATUS THEREOF, AND METHOD FOR FORMING SERVO PATTERN

(75) Inventor: Yoshinari HIGASHINO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/687,745

(22) Filed: Jan. 14, 2010

(30) Foreign Application Priority Data
Jan. 15, 2009 (JP) 2009-006860

(51) Int. Cl. G11B 21/02

(52) U.S. Cl. 360/75; G9B/21.003

(57) ABSTRACT

According to one embodiment, an information storage apparatus comprises a storage medium on which a first servo pattern having absolute position information and a second servo pattern having relative position information are recorded, a head configured to record and reproduce information on and from the storage medium, a recording signal generator configured to generate a control signal for making the head record a third servo pattern having absolute position information on the storage medium while positioning the head by using the first and the second servo patterns, and a data storage unit configured to store recording data for recording the third servo pattern on the storage medium.

### CROSS-REFERENCE TO RELATED APPLICATIONS

This application is based upon and claims the benefit of priority from Japanese Patent Application No. 2009-006860, filed Jan. 15, 2009, the entire contents of which are incorporated herein by reference.

### BACKGROUND

1. Field

One embodiment of the invention relates to an information storage apparatus, an adjustment apparatus thereof, and a method for forming a servo pattern. More specifically, the embodiment of the invention relates to an information storage apparatus configured to form a new servo pattern by using a servo pattern formed on a storage medium in advance to execute record/reproduction based on the new servo pattern, an adjustment apparatus of the storage apparatus, and a method for forming a servo pattern configured to form the new servo pattern for the storage medium.

2. Description of the Related Art

A servo pattern to be used for positioning control of a read/write head configured to execute data reading/writing for a storage medium is formed on the storage medium such as a magnetic disk to be mounted on an information storage apparatus such as a magnetic disk apparatus. The read/write head is positioned on a target track on the storage medium based on the reading result of the servo pattern.

The servo pattern to be formed on the storage medium is generally formed in a radial pattern from the inner circumference portion toward the outer circumference portion of the storage medium. Regarding other servo patterns, a servo pattern with a spiral shape and a servo pattern having a concentric servo pattern connecting to the servo pattern with the spiral shape is proposed (e.g., Jpn. Patent Appln. KOKAI Publication No. 61-59671).

The formation of the servo pattern on the storage medium is executed by an external servo track writer (STW). However, if the external servo track writer writes the servo pattern on the entire surface of the storage medium, since the writing of the servo pattern on the storage medium requires a long time, one external servo track writer is occupied for a long time period. Depending on the reason given above, since it is needed to increase the external servo track writer, there is the possibility of an increase in cost of an investment in facilities.

Conversely, in recent years, to reduce the cost of the investment in facilities for the external servo track writer, a method for magnetically writing the servo pattern within an information storage apparatus on which the storage medium is mounted is proposed (e.g., see U.S. Pat. No. 7,145,744 B1 and No. 5,668,679). In this method, the read/write head in the information recording apparatus forms the spiral servo pattern having the spiral shape, and forms the servo pattern in a radial pattern by using the spiral servo pattern.

Recently, various examinations related to practical realization of the method for forming the servo pattern with reference to the servo pattern having the spiral shape. This method forms, in advance, a first servo pattern including absolute position information at a portion of a storage medium, and also forms, in advance, a second servo pattern including relative position information on the entire surface of the storage medium, and forms a third servo pattern including the absolute position information on the entire surface of the storage medium by using the first and second servo patterns after mounting the storage medium in the magnetic storage apparatus.

However, various problems such as an accuracy problem and a cost problem have newly posed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically depicting a configuration of a magnetic disk apparatus of an embodiment of the invention.

FIG. 2 is an exemplary plane view depicting a magnetic disk (a magnetic disk before or right after mounting onto the magnetic disk apparatus) in FIG. 1.

FIG. 3 is an exemplary view depicting an expanded area on an outer circumference portion of the magnetic disk in FIG. 2.

FIG. 4 is an exemplary view depicting a flow from formation of first and second servo patterns for the magnetic disk up to test completion of the magnetic disk.

FIG. 5 is an exemplary flowchart depicting rewrite formation processing of a third servo pattern.

FIG. 6 is an exemplary view for explaining a method for forming the third servo pattern.

FIG. 7 is an exemplary flowchart depicting processing in an apparatus adjustment facility 150 of FIG. 4.

FIG. 8 is an exemplary view for explaining processing of block #68 in FIG. 7.

FIG. 9 is an exemplary view for explaining processing in an SRT facility.

### DETAILED DESCRIPTION

Various embodiments according to the invention will be described hereinafter with reference to the accompanying drawings. In general, according to one embodiment of the invention, an information storage apparatus comprises a storage medium on which a first servo pattern having absolute position information and a second servo pattern having relative position information are recorded; a read/write head configured to record and reproduce information on and from the storage medium; a recording signal generator configured to generate a control signal for making the read/write head record a third servo pattern having absolute position information on the storage medium while positioning the read/write head by using the first and the second servo patterns; and a data storage unit configured to store recording data for recording the third servo pattern on the storage medium.

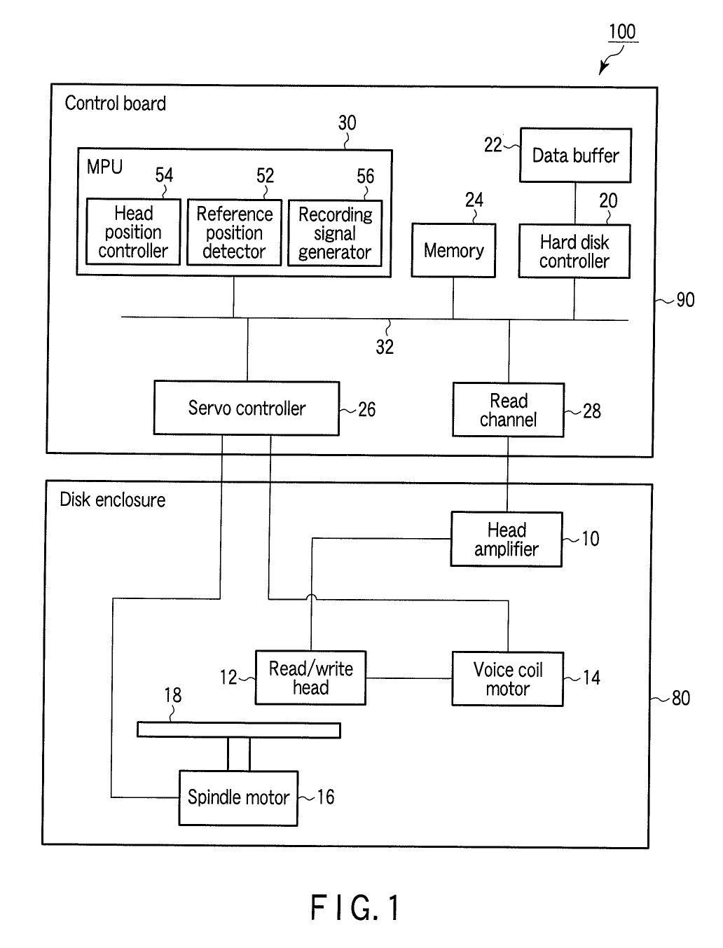

Hereinafter, one embodiment of an information storage apparatus, an adjustment apparatus thereof and a method for forming a servo pattern will be described in detail with reference to FIGS. 1-9.

FIG. 1 shows a block diagram of a magnetic disk apparatus 100 as an embodiment of the information storage apparatus of the embodiment. As shown in FIG. 1, the disk device 100 comprises a disk enclosure 80 and a control board 90.

The enclosure 80 comprises a head amplifier 10, a read/write head 12, a voice coil motor 14, a spindle motor 16, and a magnetic disk 18 as a storage medium.

The head amplifier 10 transmits data input from a read channel 28 to the read/write head 12 (as recording element), and also transmits the data read by the read/write head 12 (as reproducing element) to the read channel 28.

The read/write head 12 comprises a main unit made of ceramic, etc., a recording element built in the main unit to write information (data) on the magnetic disk 18, and a reproducing element for reading the written data.

The voice coil motor 14 drives a head stack assembly (HAS) holding the read/write head 12 under the control by a servo controller 26, and positions the read/write head 12 at a desired position on the magnetic disk 18. Under the control by the servo controller 26, the spindle motor 16 rotates the magnetic disk 18 at an appropriate rotation speed such as 4,200 to 15,000 rpm.

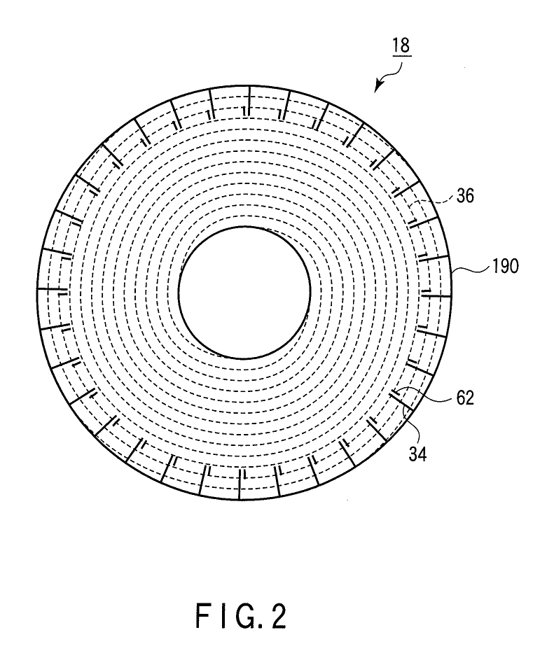

The magnetic disk 18 is a storage medium recording data thereon by varying a magnetized state of a magnetic body. On the magnetic disk 18, a servo pattern area to be used for positioning the read/write head 12, other than an area storing user data therein, is formed. Here, the magnetic disk 18 before being mounted on the enclosure 80, and immediately after being mounted thereon has a servo pattern shown in FIG. 2. More specifically, in an area adjacent to the outer circumference portions of a disk substrate 190 as a storage medium main body, the magnetic disk 18 comprises a first servo pattern formed of servo sectors 34 arranged at predetermined intervals along with a circumferential direction, and a spiral-shaped second servo pattern 36 arranged on the entire surface of the disk substrate 190.

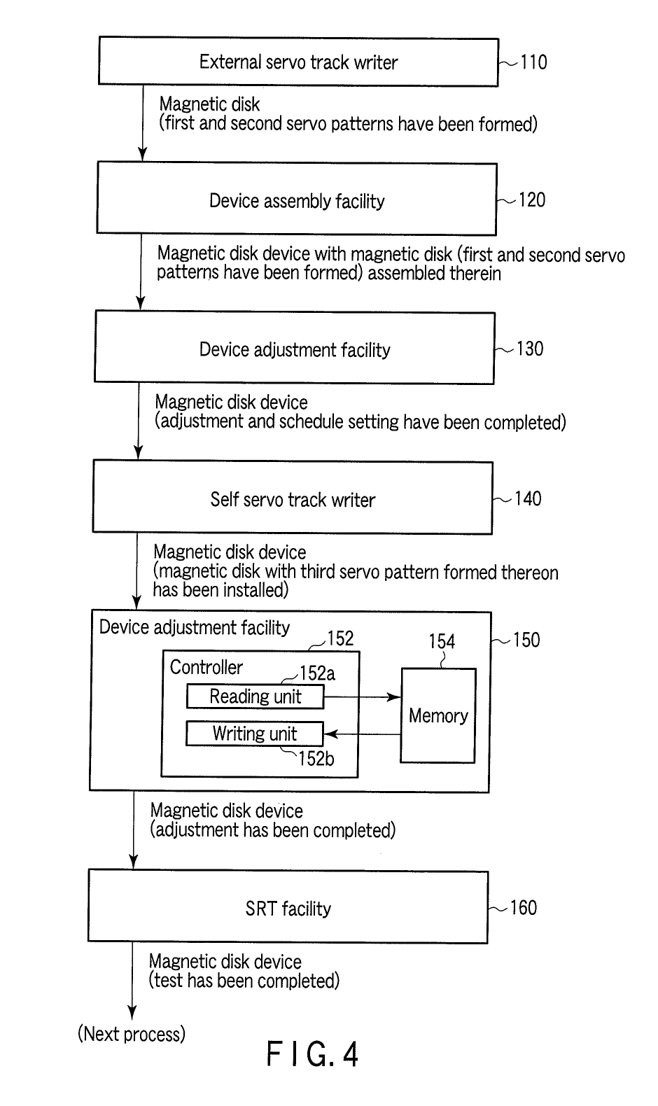

In the embodiment, while the magnetic disk 18 records a third servo pattern including absolute position information on the entire surface of the magnetic disk 18 after the magnetic disk 18 is mounted on the disk device 100, the first and the second servo patterns 34 and 36 are used for positioning the read/write head 12 for the recording. These first and the second servo patterns 34 and 36 are formed in advance by the external servo track writer (see FIG. 4).

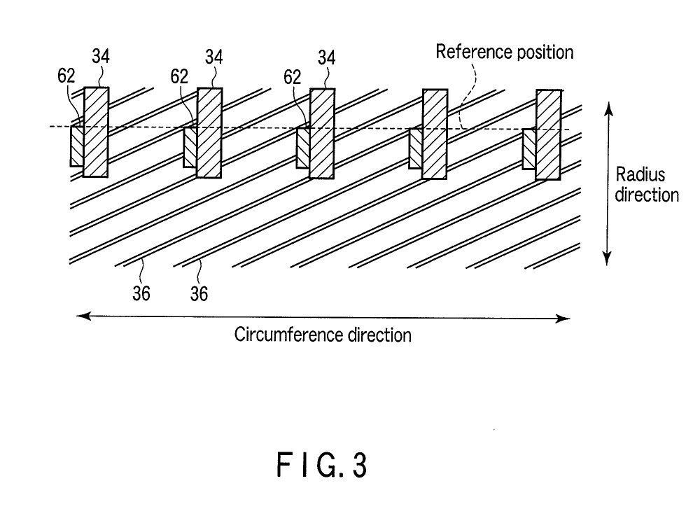

FIG. 3 illustrates a state in which portions of the areas adjacent to the outer circumference portions of the magnetic disk 18. The servo sectors 34 of the first serve pattern extend the radial direction of the magnetic disk 18 as shown in FIG. 3. That is, the servo sectors 34 are arranged in radial patterns from the outer circumference portions of the magnetic disk 18.

In fact, each of the servo sectors 34 of the first servo pattern comprises a preamble, a servo sync mark, sector data, a gray code and a phase burst. In this way, in the embodiment, since the servo sector 34 comprises the gray code, etc., the absolute position on the magnetic disk 18 can be specified by reading the servo sectors 34 of the first servo pattern through the read/write head 12. That is, the servo sectors 34 of the first servo pattern comprise the absolute position information on the magnetic disk 18.

The second servo pattern 36 is a pattern having a spiral shape, and intersects with the servo sectors 34 of the first servo pattern. The second servo pattern 36 comprises a sync mark and a burst. Among of them, the sync mark is used as reference timing information in a circumferential direction. The burst indicates the position of the second servo pattern 36 by using its amplitude peak position timing. In this way, in the embodiment, since the second servo pattern 36 do not comprise the gray code, etc., reading the second servo pattern 36 cannot specify the absolute position on the magnetic disk 18, and can specify only the relative position thereon. In other word, the second servo pattern 36 comprises the relative position information on the magnetic disk 18.

As shown in FIGS. 2 and 3, system areas 62 as temporal holding areas are arranged at the positions adjacent to the servo sectors 34 of the first servo pattern. In the system areas 62, information of a reference position, schedule data, etc., for recording the third servo pattern given below are stored.

Returning now to FIG. 1, the control board 90 comprises a hard disk controller 20, a data buffer 22, a memory 24 as a storage unit, a servo controller 26, a read channel 28, and a micro processing unit (MPU) 30. Among of them, the hard disk controller 20, the memory 24, the servo controller 26, the read channel 28 and the MPU 30 are mutually connected through a system bus 32.

The hard disk controller 20 transmits and receives various commands and a variety of items of data to and from a host system (not shown) such as a computer that is the host of the magnetic disk apparatus 100. The data buffer 22 temporarily stores the data, etc., from the host system.

The memory 24 comprises a volatile memory such as a random access memory (RAM) and a nonvolatile memory such as a flash memory. The RAM is a work memory for use in execution of control processing by the MPU 30. The flash memory may store information about a reference position for recording a third pattern and schedule data instead of the system areas 62 on the aforementioned magnetic disk 18.

The servo controller 26 controls the drives of the voice coil motor 14 and the spindle motor 16 based on the instruction from the MPU 30.

The read channel 28 functions as a write modulation unit and a read demodulation unit. The MPU 30 integrally controls the entire of the magnetic disk apparatus 100. The MPU 30 comprises a reference position detector 52, a head position controller 54, and a recording signal generator 56, as shown in FIG. 1. The detector 52 obtains the reference position of the second servo pattern 36 from the positional relationship between the first and the second servo patterns 34 and 36 read and demodulated by the read/write head 12. The head position controller 54 performs positioning control of the read/write head 12 at the desired position on the magnetic disk 18. The generator 56 generates a recording signal for making the magnetic disk 18 at the target position record the third servo pattern having the absolute position information by means of the read/write head 12 performed the positioning control at the target position.

Next, processes up to the test completion of the magnetic disk apparatus 100 with the magnetic disk 18 built therein from the formation of the first and the second servo patterns 34 and 36 for the magnetic disk 18 will be described with reference to FIG. 4.

The external servo track writer 110 forms the servo sectors 34 of the first servo pattern at the portions (outer circumference portions) of the magnetic disk 18, and also forms the second servo pattern 36 on the entire surface of the magnetic disk 18. The magnetic disk 18 which has passed the servo pattern formation processing is carried to a device assembly facility 120.

The assembly facility 120 executes processing for installing the magnetic disk 18 on which servo patterns are formed by the external servo track writer 110 into the magnetic disk 100. The magnetic disk apparatus 100 which has passed the processing is carried to a device adjustment facility 130.

The adjustment facility 130 adjusts (detects the reference position) for writing (forming) the third servo pattern in the magnetic disk 18, and stores the schedule data in the system areas 62. The magnetic disk apparatus 100 which has completed the processing mentioned above is carried to a self servo track writer 140.

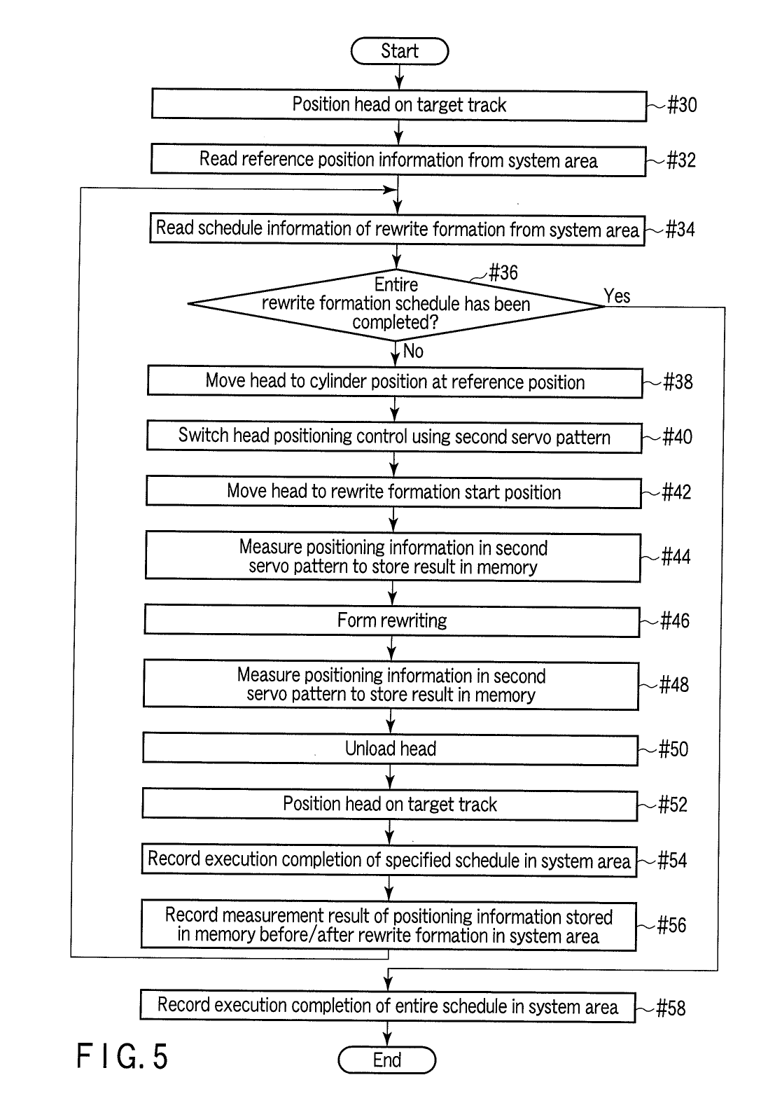

The self servo track writer 140 forms (rewrites and forms) the third servo pattern having the absolute position information on the magnetic disk 18 in accordance with the procedure shown in FIG. 5.

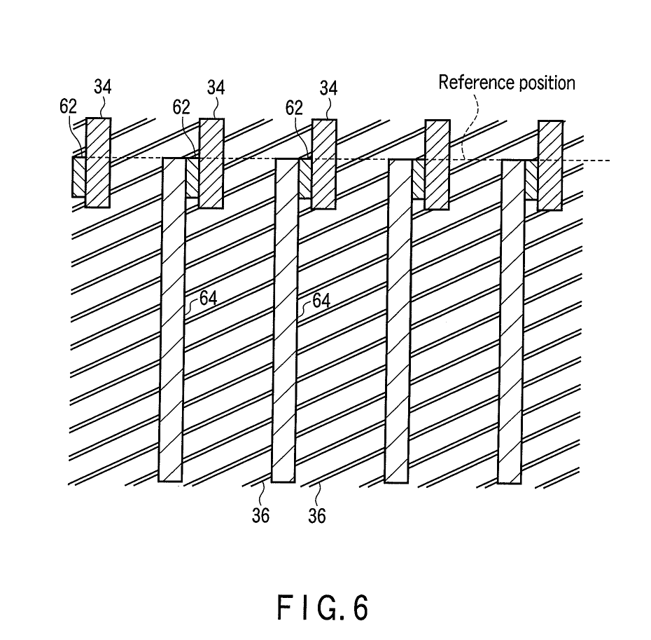

As a premise of execution of the processing shown in FIG. 5, the MPU 30 (the reference position detector 52) detects the reference position (the position starting formation of the third servo pattern, see FIG. 3) in advance, the detected information (information related to the reference position) is stored in the system areas 62. The number of times of rewriting required to be executed for forming the third servo pattern, and information (schedule data) on a cylinder position at each rewriting are stored in the system areas 62. In the embodiment, a case in which rewrite formation by one time forms servo sectors 64 forming the third servo pattern (see FIG. 6) will be described as an example.

In block #30 of FIG. 5, the MPU 30 (head position controller 54) controls the drives of the spindle motor 16 and the voice coil motor 14 through the servo controller 26, and positions the read/write head 12 on the target track within the servo sectors 34 of the first servo pattern. In this case, using the information about the gray codes and the phase bursts of the first servo pattern 34 enables the read/write head 12 to be positioned on the target track.

The MPU 30, in block #32, reads the information (information on the cylinder position) of the reference position recorded in the system areas 62. The MPU 30, in block #34, reads the schedule data of rewrite formation recorded in the system areas 62.

The MPU 30, in block #36, determines whether or not the entire rewrite formation schedule has been completed. Here, since the rewrite formation has not completed yet, the determination is not affirmative, and the process shifts to block #38. In block #38, the MPU 30 (head position controller 54) controls the spindle motor 16 and the voice coil motor 14 through the servo controller 26 to move the read/write head 12 from the system areas 62 to the read reference position (see FIG. 3). For the movement, the MPU 30 (head position controller 54) uses the information about the gray codes and the phase bursts of the first servo pattern 34, etc.

The MPU 30, in block #40, switches from the positioning control using the first servo pattern 34 to the positioning control using the second servo pattern 36. Then, the MPU 30 (head position controller 54), in block #42, moves the read/write head 12 to a rewrite formation start position based on the schedule data read from the system areas 62. Since, in the embodiment, the MPU 30 performs the rewrite formation only one time, and the rewrite formation start position is set to the foregoing reference position, the movement of the read/write head 12 in block #42 is not executed. However, in block #42 in the processing after the second time in a case in which the rewrite formation is performed while dividing the rewrite formation into a plurality of times, the vicinity of the completion position of the last rewrite formation is set as the rewrite formation start position.

The MPU 30 (head position controller 54), in block #44, measures the positioning information (recording data) using the second servo pattern 36 before rewrite formation to store the measurement result in the memory 24. Here, in the measurement of the positioning information, the MPU 30 uses the second servo pattern 36 to execute the positioning control of the read/write head 12. When the positioning to the target cylinder is completed, the MPU 30 acquires positioning information (position error information) from the difference between the target cylinder position and the current position to be acquired from the demodulation result of the second servo pattern 36. The MPU 30 temporarily stores the positioning information in the memory 24 of the magnetic disk apparatus 100 for each data item of the second servo pattern 36. For instance, if there are 200 data items of the second servo pattern 36 on the circumference portions of the magnetic disk 18, the MPU 30 stores the positioning information of a full circle (200) in the memory 24.

Although it is ideally preferable for the measurement of the positioning information to be executed to all cylinders, since the number of the cylinders is an order of 100 thousands, etc., from a viewpoint of a recording size, such measurement is not realistic. Therefore, for example, the MPU 30 executes the measurement in response to the conditions of before rewrite formation start, after rewrite formation start, or before and after the rewrite formation in accordance with the positioning information selection mode to be specified by the rewrite formation schedule. For instance, the MPU 30 divides the entire surface into each several zone to record the positioning information of 10 cylinders before the rewrite start, and records the positioning information of another item of positioning information of 10 cylinders after the rewrite start.

The MPU 30 generates a recording signal for forming the third servo pattern 64 by using the head position controller 54 while positioning the read/write head 12 by using the second servo pattern 36 by means of the recording signal generator 56 (block #46). In this case, the servo sectors 64 of the third servo pattern are formed at a position deviating in a circumference direction from the servo sectors 34 of the first servo pattern and the system areas 62, as shown in FIG. 6. When forming the third servo pattern 64 on the magnetic disk 18, the MPU 30 forms the servo sectors 64 of the third servo pattern in sequence while moving the read/write head 12 in the radius direction.

As mentioned above, the second servo pattern 36 has the relative position information on the magnetic disk 18, and the reference position of the second servo pattern 36 has the absolute position information. Therefore, the MPU 30 executes the positioning control of the read/write head 12 from the reference position of the second servo pattern 36, uses the second servo pattern 36 after this, and then, can perform positioning control of the read/write head 12 while specifying the absolute position on the magnetic disk 18.

In this way, after completing the rewrite formation, the MPU 30 (head position controller 54), in block #48, measures the positioning information using the second servo pattern 36 to store the result in the memory 24.

In block #50, the MPU 30 (head position controller 54) stops the positioning control using the second servo pattern 36 to unload the read/write head 12 outside the magnetic disk 18.

The MPU 30 (head position controller 54), in block #52, uses the information of the gray codes and the phase bursts of the first servo pattern 34 again, positions the read/write head 12 on the target track within the first servo pattern 34. In the aforementioned block #50, the MPU 30 unloads the read/write head 12 outside the magnetic disk 18 once, because it is necessary to switch the positioning control of the read/write head 12 from the second servo pattern 36 to the first servo pattern 34.

The MPU 30 records the completion of the rewrite formation in the system areas 62 in block #54.

In block #56, the MPU 30 records the measurement result stored in the memory 24 before and after the rewrite formation (blocks #44, #48) in the system areas 62.

The MPU 30 reads the schedule data of the rewrite formation and the information of the completion of the rewrite formation (block #34) to determine whether or not the entire rewrite formation schedule has been completed (block #36). Based on the schedule data of the rewrite formation and the information of the completion of the rewrite formation read from the system areas 62, if the MPU 30 determines that the entire rewrite formation schedule has been completed, the determination in block #36 is affirmed and shifts the process to block #58.

The MPU 30 records the completion of the entire rewrite formation in the system areas 62 in block #58 then completes all processes in FIG. 5.

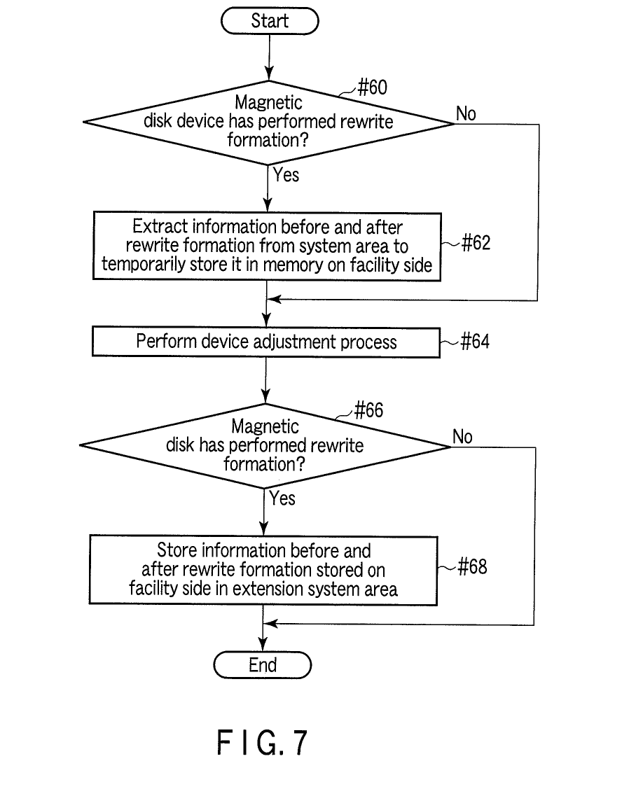

Returning to FIG. 4, the magnetic disk apparatus 100 of which the processing in FIG. 5 has been completed is carried to the device adjustment facility 150 that is an adjustment apparatus of the information storage apparatus. In the adjustment facility 150, the controller 152 of the adjustment facility 150 executes the processing of the flowchart in FIG. 7. The controller 152 of the adjustment facility 150 has a reading unit 152a and a writing unit 152b, and each of them is connected to the memory 154.

The controller 152 of the device adjustment facility 150 determines whether or not the magnetic disk apparatus to be adjusted is the magnetic disk apparatus in which the rewrite formation has been performed in block #60 of FIG. 7. In block #62, if the determination here is affirmative, the controller 152 (reading unit 152a) uses the read/write head 12 to extract the information (measurement result of positioning information) before and after the rewriting formation stored in the system areas 62, and temporarily stores the information in the memory 154. Here, another item of information (e.g., information of the cylinder positioned at the outer most circumference portion (inter most circumference portion) in rewrite formation, a setting value of a writing current in rewrite formation, a dynamic flying height (DFH) setting value, etc.) stored in the system areas 62 may be extracted to be stored in the memory 154. In the process in which the extraction and the storage processing of the information have completed, the process shifts to block #64.

If the determination in block #60 is not affirmative, the process jumps block #62 to shift to block #64.

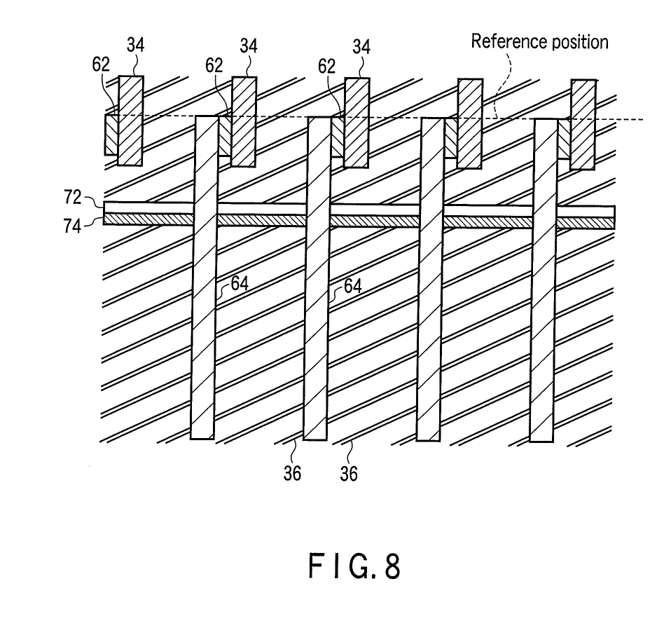

In block #64, the controller 152 executes a device adjustment process for a self running test (SRT). In the adjustment process, the controller 152 sets an SRT schedule, etc., and stores the information in a circular area (system area) 72 with a predetermined width preset on the magnetic disk 18 as shown in FIG. 8.

In block #66, the controller 152 determines whether or not the magnetic disk apparatus 100 to be adjusted is one in which the rewrite formation has been completed. If the determination here is affirmative, the process shifts to block #68. In Block #68, the controller 152 (writing unit 152b) uses the recording/reducing head 12 to store the measurement result of the positioning information before and after the rewriting formation, etc., temporarily stored in the memory 154 in circular area (extension system area) 74 having a predetermined width on the magnetic disk 18, and terminates the entire process of FIG. 7.

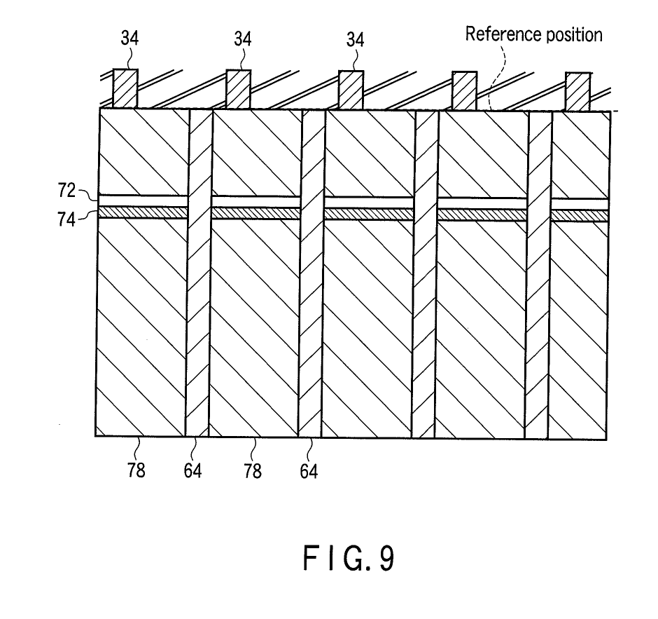

Returning to FIG. 4, the magnetic disk apparatus 100 via the device adjustment facility 150 is carried to an SRT facility 160. The SRT facility 160 uses the read/write head 12 to actually record test data 78, as shown in FIG. 9, and confirms whether or not an error occurs by reading the recorded test data 78.

In the SRT facility 160, if any problem has posed for positioning the read/write head 12, the MPU 30 can read and analyze the measurement result of the positioning information recorded in the extension system area 74. The analysis enables determining whether or not the posed problem is caused from the influence in the rewrite formation. More specifically, for example, the MPU 30 specifies an oscillation component to be input from the SRT facility 160 in rewrite formation by applying spectrum analysis to the positioning information to specify a frequency component to be a problem. As the analysis result, if it is determined that there is a problem in rewrite formation precision, it is possible to specify a point to be improved in rewrite formation such as an improvement in facility oscillation characteristic, an improvement in a characteristic of the servo controller 26, and a design change in the magnetic disk apparatus 100. It is possible for the analysis to be executed in a case where there is a problem after the shipment of the magnetic disk apparatus 100.

In this way, when the test by the SRT facility 160 has been completed, the process shifts to the next test process shown in FIG. 4.

As cleared from the description given above, in the embodiment, the data acquisition unit is composed of the read/write head 12, the head amplifier 10, the read channel 28 and the MPU 30.

As described above in detail, according to the embodiment, the extension system area 74 stores the measurement results of the positioning information that is the information at the time (before and after recording) when the third pattern 64 is recorded on the magnetic disk 18 by using the first and the second servo patterns 34 and 36. Here, as the embodiment, when performing the rewrite formation of the third pattern 64 in the magnetic disk 18 in the magnetic disk apparatus 100, it has become clear that the rewrite formation precision is influenced by the combination of various factors. Regarding the factors, for example, the combination of various factors, such as a device mechanical characteristic of the rigidity and the weight, etc., of the magnetic disk apparatus 100 itself, the quality of the second servo pattern 36 formed in advance by the external servo track writer 110, the servo characteristic of the servo controller 26, and the facility mechanical characteristic of the rigidity and the weight, etc., of the facility in which the magnetic disk apparatus 100 is installed for rewrite formation, is cited. Conversely, in the embodiment, as mentioned above, since the measurement result of the positioning information that is the information for recording (before and after recording) the third servo pattern 64 is stored, after the recording of the third servo pattern 64, the magnetic disk apparatus 100 can apply precise positioning control to the read/write head 12 by referring or analyzing the recorded positioning information in a case where the magnetic disk apparatus 100 performs the positioning control of the read/write head 12 using the third servo pattern 64.

According to the embodiment, since the measurement result of the positioning information stored in the system areas 62 is restored in the extension system area 74, even if the system areas 62 are overwritten (deleted) by the test data 78 (see FIG. 9) in the SRT facility 160, the magnetic disk apparatus 100 can continuously store the measurement result of the positioning information on the magnetic disk 18.

While the embodiment has described a case where the magnetic disk apparatus 100 stores the measurement results in the extension system area 74 of the magnetic disk 18, the invention is not limited to the embodiment. For instance, the measurement results of the positioning information may be stored in other areas in the magnetic disk 18. The measurement results may be stored in other than the magnetic disk 18, for example, in the memory 24 in FIG. 1. In short, the measurement results may be stored in places from which the measurement results can be read quickly when the problem occurs in the positioning control of the read/write head 12.

While the embodiment has described a case where the measurement results of the positioning information are restored in the extension system areas 74 after recording the measurement result once in the system areas 62, the invention is not limited to the embodiment, and the measurement result may be stored in the extension system areas 74 from the first.

While the embodiment has described a case where the measurement results are restored in the extension area 74 from the system areas 62, the invention is not limited to the embodiment. For instance, in the SRT facility 160, if the system areas 62 are not deleted by the test data 78, the measurement results may be continued to be stored in the system areas 62.

While the embodiment has described a case where the servo sectors 34 of the first servo pattern are arranged near the outer circumference portions of the magnetic disk 18, the invention is not limited to the embodiment. The first servo pattern 34 may be arranged near the inner circumference portions. The first servo pattern 34 may be arranged at both the inner circumference portions and the outer circumference portions. The system areas 62 may be disposed near the inner circumference portions of the magnetic disk 18, and may be disposed at both the inner circumference portions and the outer circumference portions.

While the embodiment has described a case where the servo sectors 64 of the third servo pattern are formed through the one time of rewrite formation, the invention is not limited to the embodiment. The third servo pattern 64 may be formed through a plurality of times of rewrite formation.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

According to the information storage apparatus of the embodiment, since the data storage unit stores the recording data that is the information for recording the third servo pattern on the storage medium by using the first and the second servo patterns, in the positioning control of the read/write head 12 using the third servo pattern after recording the third servo pattern, it is possible to contribute to realize precise positioning control of the read/write head 12 by referring to the recording data and analyzing the data.

According to the adjustment apparatus of the information storage apparatus of the embodiment, since the recording data temporarily stored in a holding area is restored in a storage area, for example, even if the holding area is overwritten later by the data such as test data and user data, the recoding data can be continuously stored in the storage medium.

According to the method for forming the servo pattern of the embodiment, since the recording data that is the information for recording the servo patterns on the storage medium by using the first and the second servo patterns is stored, the recording data can be provided if there is a problem in the positioning control of the read/write head 12 using the third pattern after recording the third servo pattern. Thereby, the method can contribute to realize the accurate positioning control of the read/write head.

What is claimed is:

1. An information storage apparatus comprising:
a storage medium configured to store a first servo pattern comprising absolute position information and a second servo pattern comprising relative position information;
a head configured to record information on the storage medium and to reproduce information from the storage medium;
a recording signal generator configured to generate a control signal which causes the head to record a third servo pattern comprising the absolute position information while positioning the head by using the first and the second servo patterns; and
a data storage module configured to store recording data for recording the third servo pattern on the storage medium.

2. The apparatus of claim 1, further comprising:
a data receiver configured to receive the recording data.

3. The apparatus of claim 1, wherein the data storage module comprises a storage area on the storage medium.

4. The apparatus of claim 3, further comprising:
a temporal storage area configured to temporarily store the recording data.

5. An adjustment apparatus of an information storage apparatus, the information storage apparatus comprises:
a storage medium configured to store a first servo pattern comprising absolute position information and a second servo pattern comprising relative position information;
a head configured to record information on the storage medium and to reproduce information from the storage medium;
a recording signal generator configured to generate a control signal which causes the head to record a third servo pattern comprising the absolute position information while positioning the head by using the first and the second servo patterns;
a data storage module configured to store recording data for recording the third servo pattern on the storage medium, and comprising a storage area on the storage medium; and
a temporal storage area configured to temporarily store the recording data,
wherein the adjusting apparatus comprises:
a reader configured to read the recording data in a temporal storage area of the information storage apparatus; and
a writer configured to write the read recording data in the storage area by using a head of the information storage apparatus.

6. A method for forming a servo pattern comprising:
forming a third servo pattern comprising absolute position information on a storage medium comprising a first servo pattern comprising the absolute position information and a second servo pattern comprising relative position information while positioning a head by using the first and the second servo patterns; and
storing recording data for recording the third servo pattern on the storage medium.

7. The method of claim 6, further comprising:
receiving the recording data.
